(19) United States
(12) Patent Application Publication
(10) Pub. No.: US 2015/0114822 A1
(43) Pub. Date: Apr. 30, 2015

(54) Photocatalytic Oxidation Apparatus for Oxidizing Volatile Organic Compounds

(71) Applicant: Richard J. Greco, Hernando, FL (US)

(72) Inventor: Richard J. Greco, Hernando, FL (US)

(21) Appl. No.: 14/182,050

(22) Filed: Feb. 17, 2014

Related U.S. Application Data
(60) Provisional application No. 61/896,498, filed on Oct. 28, 2013.

(51) Int. Cl. B01J 19/12

(52) U.S. Cl. CPC B01J 19/123
USPC 204/158.21; 422/171

(57) ABSTRACT

The present invention provides a method of oxidizing VOCs to carbon dioxide and water in a photo catalytic environment by passing the VOC laden industrial effluent through a filter tube containing a porous inorganic substrate, impregnated and surface coated with TiO₂ powder, present within an Ultra Violet light/ozone/hydroxyl flux field. The porous inorganic substrate includes at least one multiple wavelength type C UV lamp of wavelengths between and/or in combinations of 185 and 285 nm. The lamp is placed in parallel and in the center of the filter tube, allowing maximum radiation to reach the TiO₂ surface to enhance its catalytic activity. The lamp is further encapsulated in an air purged, UV transparent annular quartz tube to maintain an ambient temperature of less than 50° C. The purged air passing through the quartz tube further provides ozone/hydroxyl, formed by the contact of oxygen and humidity in the purged air with UV light, which assists in oxidation of volatile organic compounds.

### CROSS-REFERENCE TO RELATED APPLICATIONS

This application claims priority of provisional patent application No. 61/896,498, filed on Oct. 28, 2013, the contents of which are incorporated herein in their entirety by reference.

### TECHNICAL FIELD OF THE INVENTION

The technical field of the invention relates to photocatalytic oxidation devices, designs and processes for cold catalytic oxidation of vapor-borne volatile organic compounds (VOCs). The technical field of the invention also relates to improved methods for oxidizing VOCs using a photochemical oxidation process comprising a UV radiation source capable of generating a UV type C radiation, with a wavelength of below 360 nm, to provide the means to activate a powdered TiO₂ catalyst with improved oxidation capability, and a short wavelength UV type-C radiation, with a wavelength of below 200 nm, for generating O₃ from oxygen.

### BACKGROUND OF THE INVENTION

Common methods known in the art for destroying VOCs that are released as fumes or gaseous vapors from industrial effluent involve heating of the effluent prior to its passage through a catalyst to oxidize the compounds present in the effluent. The temperature at which the VOCs are oxidized (destroyed) to form water vapor and carbon dioxide depends upon the type of catalyst used. These temperatures range from about 400° F. to greater than about 800° F. These means for destroying VOCs require additional fuel to preheat the fume to a catalyzing, oxidation temperature. Consequently, these techniques for oxidizing VOCs are expensive to operate even when heat exchangers are used to preheat the fume using hot exhaust gases for the system.

In all typical Catalytic Thermal Oxidizers (CTO) the drawbacks involve the cost of the device, the cost to replace spent catalyst, excessive amounts of fuel consumed to bring the VOC laden fume to catalytic oxidation temperature, and the cost of electric power consumption.

It is understood that virgin fuel usage can be reduced by using an air-to-air heat exchanger in series with the CTO to preheat the incoming fume close to the oxidation temperature using transferred oxidation heat. The virgin fuel usage can be reduced especially well when the fume has enough caloric value to negate fuel usage, which is typically not the case. However, this does not negate the power required to move the fume through the high pressure drop CTO.

The Photo Catalytic Oxidizer (PCO) Technology.

To minimize fuel use, power consumption, and equipment costs, certain inexpensive catalysts can be excited without heat by using UV radiation at close to ambient temperatures. The present invention provides a means to oxidize VOCs present in industrial effluents, e.g., gaseous vapors, using a photo catalytic oxidizing agent such as TiO₂, in a UV flux field. The oxidation of VOCs is effective when the effluent containing VOCs is passed over TiO₂ irradiated with a UV source of less than 285 nm, such as 185 nm.

The marginal destruction effectiveness of VOCs using a PCO process, using TiO₂ (and/or a mixture of other catalyzing agents such as tungsten or copper) as the catalyst is well known. The present invention provides a means to increase the Total Destruction Efficiency (TDE) to an acceptable level that will comply with government regulations for destroying VOCs.

Because of the complexity of different VOC hydrocarbon chains, the present device is not intended to cover all VOCs, but instead is directed to those hydrocarbons that work well with Photochemical Thermal Oxidation (PTO) such as, but not limited to, specific compounds such as carbon monoxide, ethyl acetate (C₄H₈O₂), ethylene glycol (C₂H₅OH), toluene (C₇H₈) and xylene (C₈H₈), as well as a large portion of the VOC-destruction equipment marketplace serving printers and manufactures of polystyrene products, i.e., the VOCs associated with printers, printer manufacturing, and polystyrene use in manufacturing.

Past PTO systems are believed to fall short of acceptable total destruction efficiency for the reasons described in U.S. Pat. Nos. 6,551,561; 6,531,035; 6,342,128; 6,334,936 and 6,309,611. Poor total destruction efficiency of VOCs is believed to be mainly due to poor dwell time, poor surface contact of the VOC to the catalyst impregnated media substrate, type of catalyzing material substrate, inefficient coverage of the UV flux over the substrate media surface, and the marginal efficiency of the UV wavelength used. Further, the sol-gel method of coating the surface of organic media substrate described in these patents is expensive and has limitations in distribution, UV deterioration, and working temperature constraints. In most cases, because of the non-porous nature of the media substrate, sol-gel TiO₂ can typically be applied to cover only the surface of the media. Further, the sol-gel TiO₂ is known to penetrate and clog the passageways, thereby obstructing the flow of an effluent containing VOCs.

To overcome the problems associated with the prior art, the inventor has identified a need to develop a simple, efficient, room or low temperature operable, photochemical oxidation device comprising a UV activated catalyst in an ultraviolet (UV) light/ozone flux field for oxidizing VOCs present in the industrial effluents. In some implementations, the device operates without the need to provide a source of heat beyond that heat incidentally generated by the UV lamp that generates the UV light.

### SUMMARY OF THE INVENTION

In one general aspect, the invention relates to a photocatalytic oxidation system for catalytic oxidation of volatile organic compounds (VOCs). The system includes at least one porous filter tube, a catalyst, at least one UV transparent quartz sleeve, and at least one UV lamp.

The porous filter tube has a first end, a second end and a first longitudinal channel extending the length of the filter tube between a first opening at the first end of the porous filter tube and a second opening at the second end of the porous filter tube. The porous filter tube has a wall extending between an inner surface surrounding the channel and an outer surface. The wall is porous, having pores with an average pore diameter.

The catalyst includes TiO₂ having a particle size that is greater than the average pore diameter on the surface of the inner surface of the wall.

The UV transparent quartz tube has a first end, a second end and a second longitudinal channel extending the length of the tube between a first opening at the first end of the tube and a second opening at the second end of the tube. The tube has an inner diameter and is positioned within the first longitudinal channel of the filter tube.

The UV lamp is capable of producing UV light and has an outer surface defining an outer diameter of the UV lamp. The outer diameter of the UV lamp is less than the inner diameter of the quartz tube. The UV lamp is positioned within the second longitudinal channel of the quartz tube such that a space is formed between the outer surface of the lamp and an inner surface of the quartz tube.

The distance between the outer surface of the lamp and the inner surface of the filter tube is less than about 2.5 inches. During operation purged air is passed through the space between the outer surface of the lamp and the inner surface of the quartz tube and is exposed to a UV light generated by the UV lamp to convert at least a portion of the oxygen and ambient humidity in the air to ozone and hydroxyls. The UV light from the UV lamp contacts the TiO₂ surface to activate the TiO₂ catalyst.

Embodiments of the photocatalytic oxidation system may include one or more of the following features. For example, the UV lamp may provide an upper end UV type C radiation and an ultra-short wavelength type C radiation. The upper end UV type C radiation may have a wavelength of below about 285 nm and the ultra-short wavelength type-C radiation may have a wavelength of below about 200 nm, such as about 185 nm. The UV lamp may have a single wavelength at about 285 nm.

The photocatalytic oxidation system may further include a first plenum, a second plenum and an exhaust plenum. The first opening of the filter tube opens to the first plenum, the second opening of the filter tube opens to the second plenum and the filter tube passes through the exhaust plenum such that the outer surface of the filter tube wall is within the exhaust plenum. The first plenum is generally sealed off from the exhaust plenum and the second plenum is generally sealed off from the exhaust plenum such that a gas in either the first plenum or the second plenum cannot enter the exhaust plenum through a wall separating the exhaust plenum from either the first plenum or the second plenum.

The photocatalytic oxidation system may further include an inlet tube to the first plenum and the second plenum and an exhaust tube from the exhaust plenum such that gas flowing in the inlet tube must pass through either or both of the first plenum and the second plenum, and then into the first longitudinal channel in the filter tube. From the first longitudinal channel the gas passes through the wall of the filter tube, into the exhaust plenum and out through the exhaust tube.

The photocatalytic oxidation system may further include a blower in either or both of the inlet tube and the exhaust tube.

The photocatalytic oxidation system may further include a source of air flow into the first opening in the quartz tube, whereby during operation the purge air passing through the space between the outer surface of the lamp and the inner surface of the quartz tube will pass out of the second opening in the quartz tube into the second plenum.

The photocatalytic oxidation system may further include an inlet header communicating with the first plenum and the second plenum.

The distance between the outer surface of the lamp and the inner surface of the filter tube may be less than about 2.5 or less than about 2.0 inches. The distance between the outer surface of the lamp and the inner surface of the filter tube may be less than about 1.5 inches.

The catalyst may further include cobalt.

The system may further include an infra-red heater to heat the filter tubes from the rear thus increasing the catalytic activity of the TiO₂ within the substrate of the filter tubes. In another implementation, the system may be free of an infra-red heater or other source of heat, other than the incidental heat generated by the UV lamp in producing UV light.

In another general aspect, the invention relates to a method for treating a gas containing volatile organic compounds. The method includes providing a photocatalytic oxidation system comprising at least one porous filter tube, a catalyst, at least one UV transparent quartz tube and at least one UV lamp.

The porous filter tube has a first end, a second end and a first longitudinal channel extending the length of the filter tube between a first opening at the first end of the porous filter tube and a second opening at the second end of the porous filter tube. The porous filter tube has a thin wall extending between an inner surface surrounding the channel and an outer surface. The wall is porous and has pores having an average pore diameter.

The catalyst includes TiO₂ having a particle size that is greater than the average pore diameter of the pores within the wall.

The UV transparent quartz tube has a first end, a second end and a second longitudinal channel extending the length of the quartz tube between a first opening at the first end of the quartz tube and a second opening at the second end of the quartz tube. The quartz tube has an inner diameter and is positioned within the first longitudinal channel of the filter tube.

The UV lamp is capable of producing UV light and has an outer surface defining an outer diameter of the UV lamp. The outer diameter of the UV lamp is less than the inner diameter of the quartz tube. The UV lamp is positioned within the second longitudinal channel of the quartz tube such that a space is formed between the outer surface of the lamp and an inner surface of the quartz tube.

The method includes (a) passing the VOC-laden gas into the first and second openings of the first longitudinal channel of the porous filter tube and through the walls of the porous filter tube; and (b) powering the UV lamp to provide UV light, whereby the UV light activates the TiO₂ catalyst to oxide at least a portion of the VOCs in the VOC-laden gas as the gas passes through the catalyst.

Embodiments of the method may include one or more of the following features or those described above. For example, the method may further include providing purge air to a first opening into the space between the outer surface of the UV lamp and the inner surface of the quartz tube, the purge air passing through the space from the first opening to the second opening and out of the second opening and into either the first opening or the second opening of the porous filter tube. The UV light from the UV lamp converts at least a portion of the oxygen and water vapor within the ambient purge air to ozone and other hydroxyls.

The distance between the outer surface of the lamp and the inner surface of the filter tube may be less than about 2.0 inches. The purged air may be maintained an ambient temperature of less than 50° C. to cool the UV lamp. The UV lamp may have an output of wavelengths between and/or in combinations of 185 and 285 nm.

The method may further include passing the purge air, ozone, and hydroxyls from the second opening of the quartz sleeve into either the first opening or the second opening of the first longitudinal channel of the porous filter tube.

The photocatalytic oxidation system may further include a first plenum, a second plenum and an exhaust plenum. The first opening of the filter tube opens to the first plenum, the second opening of the filter tube opens to the second plenum and the filter tube passes through the exhaust plenum such that the outer surface of the filter tube wall is within the exhaust plenum. The first plenum is generally sealed off from the exhaust plenum and the second plenum is generally sealed off from the exhaust plenum such that a gas in either the first plenum or the second plenum cannot enter the exhaust plenum through a wall separating the exhaust plenum from either the first plenum or the second plenum. The method may further include passing the VOC-laden gas from the first and second plenums into the first and second openings of the first longitudinal channel.

The photocatalytic oxidation system further include an inlet tube to the first plenum and the second plenum and an exhaust tube from the exhaust plenum, and a blower in either or both of the inlet tube and the exhaust tube. The method may further include using the blower to move the VOC-laden gas from the inlet tube to the first and second plenum, into the first and second openings in the longitudinal channel of the porous filter tube, through the wall of the porous filter tube into the exhaust plenum, and to the exhaust tube. The gas flowing in the inlet tube must pass through either or both of the first plenum and the second plenum, into the first longitudinal channel in the filter tube, through the wall of the filter tube, into the exhaust plenum and out through the exhaust tube.

The VOCs that are treated may include, but are not limited to, carbon monoxide, ethyl acetate, ethylene glycol, toluene, and xylene.

The catalyst may further include cobalt.

The method may further include heating the filter tubes from the rear with an infra-red lamp located in the exhaust plenum. In another implementation, the method may be characterized as being free of applying outside heat to the rear of the filter tubes other than that heat generated from the UV lamp.

In another general aspect, the invention relates to a method of oxidizing volatile organic compounds (VOCs) in a gas effluent. The method includes passing a VOC-laden gaseous vapor through a filter tube containing a porous inorganic substrate, impregnated and surface coated with TiO₂ powder. The filter tube and coating is present within an UV light/ozone flux field. The UV light is operated at wavelengths between and/or in combinations of 185 and 285 nm and the UV light is generated by a lamp that is encapsulated in an air purged, UV transparent quartz tube such that ozone and hydroxyls are created by contact of the UV light with the oxygen in the purge air and the ozone, hydroxyls and purge air pass through the filter tube with the VOC-laden gaseous vapor.

Embodiments of the invention may include one or more of the features described above or those described herein. For example, the porous inorganic substrate can be made of activated carbon fiber. The method may further include applying heat to the rear of the filter tube with an infra-red lamp. In another implementation, the method may be characterized as being free of applying outside heat to the gaseous vapor other than that heat generated from the UV lamp.

In one implementation, the photocatalytic oxidation system and method may consist of, or consist essentially of, at least one filter tube having a channel coated with TiO₂ and at least one UV light within the filter tube to irradiate the circumferential TiO₂ coated surface of the channel through the filter tube to activate the TiO₂ catalyst to treat a gas passing through the channel. Similarly, the photocatalytic oxidation system and method may consist of, or consist essentially of, the filter tube having a channel coated with TiO₂ and at least one UV light within the filter tube to irradiate the circumferential surface TiO₂ coated surface of the channel through the filter tube to activate the TiO₂ catalyst, at least one quartz tube surrounding the UV light and positioned within the channel, and a means to provide a purge air stream through the quartz tube to permit generation of ozone and hydroxyls that is fed to the channel in the filter tube for treating VOCs passing through the channel into the filter tube. The system and method may be free of additional means for treating the VOCs in the gas, in particular the addition of heat. In another implementation, the system and method may consist of, or consist essentially of, the features above and an infra-red heater to provide additional heat to the filter tubes and TiO₂ to provide further oxidation of the VOCs. In this manner, the system and method can provide a substantial energy savings when no additional heat is provided (e.g., no infra-red heater is used) or can provide enhanced cleaning capabilities if additional heat is provided.

### BRIEF DESCRIPTION OF THE DRAWINGS

FIG. 1 is a schematic plan view of the photocatalytic oxidation system showing TiO₂ impregnated inorganic porous filter tubes present within an ultraviolet light/ozone flux field.

FIG. 2 is a detailed view of air purged UV transparent quartz tube enclosing the UV lamp showing the lamp receiving socket, entrance for the purge cooling air, and exit for the purge cooling air with ozone.

FIG. 3 is a cross-section side view of the arrangement of one filter tube, one quartz tube and one UV lamp within the chamber of FIG. 1.

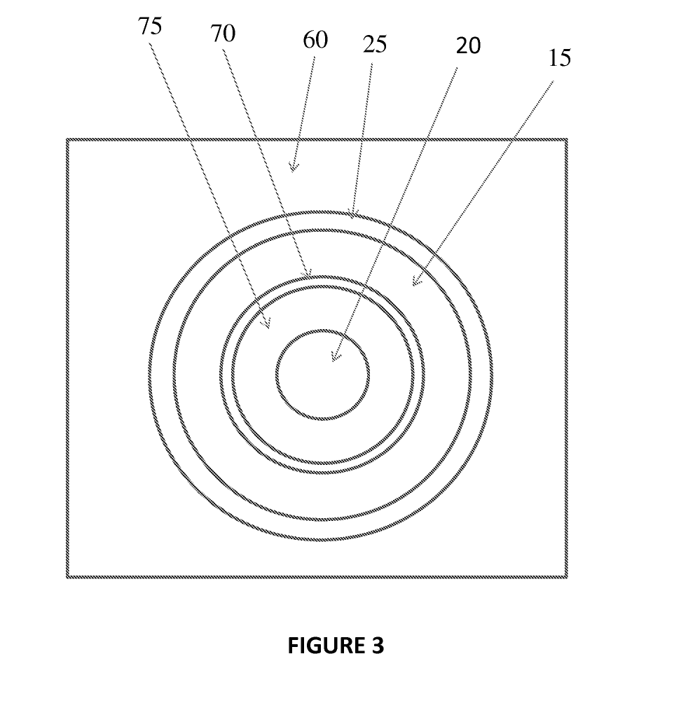

### DETAILED DESCRIPTION OF THE INVENTION

The present application provides a method of oxidizing VOCs to carbon dioxide and water in a photo catalytic environment by passing the VOC-laden, industrial vapor effluent through a filter tube containing a porous inorganic substrate, such as activated carbon fiber. The porous substrate is impregnated with powdered TiO₂ or surface sol-gel coated with TiO₂ powder and/or a mixture of other catalyzing agents such as tungsten, copper, cobalt, etc., present within an ultraviolet light/ozone flux field.

The porous inorganic substrate includes at least one multiple wavelength type C, UV lamp of wavelengths between and/or in combinations of 185 and 285 nm. The lamp is placed in parallel and in the center of the filter tube, at approximately 1.25″ proximity to the tube's inner surface. This placement of the lamp with respect to the filter tube provides a complete circumferential, maximum radiation exposure of 360 degrees of the UV light against the TiO₂ surface and enhances the TiO₂ catalytic activity. The lamp is further encapsulated in an air purged UV transparent annular quartz tube to maintain an ambient temperature of less than about 50° C. The purged air passing through the annular sleeve further generates ozone and hydroxyls based on the contact of the oxygen and humidity in the purged air with UV light. The ozone and hydroxyls are both superior chemical oxidizing agents and assist in oxidation of the VOCs. In this manner, there are three mechanisms used to clean the VOC-laden effluent gas: TiO₂ catalyst, UV-radiation, and ozone.

The present invention further provides a pre-packed photocatalytic oxidation device comprising a multiple wavelength UV radiation source and a TiO₂ catalyst. The UV radiation source provides an upper end UV type C radiation and an ultra-short wavelength type C radiation. In one embodiment of the invention, the upper end UV type C radiation has a wavelength of below 285 nm, and the ultra-short wavelength type-C radiation has a wavelength of below 200 nm, such as 185 nm. In a most preferred embodiment of the invention, the UV radiation source is a single wavelength UV lamp with a wavelength of 185 nm.

The upper end UV type-C radiation from the source is used to convert the TiO₂ catalyst to an activated TiO₂ catalyst having aggressive photochemical oxidation ability to oxidize the VOCs to CO₂ and H₂O. In one embodiment of the invention, the VOCs may comprise carbon monoxide, ethyl acetate, ethylene glycol, toluene, and xylene. In another embodiment of the invention, the device may be used in the VOC-destruction equipment marketplace serving printers and manufactures of polystyrene products.

The ultra-short wavelength radiation from the UV lamp is used to generate ozone (O₃) from oxygen (O₂) and hydroxyls from the water vapor within the purge air which will further chemically oxidize the VOCs and process the VOC fumes to further aid in the oxidation of the VOCs to convert them to CO₂ and H₂O. In still another embodiment of the invention, small amounts of cobalt are present with the TiO₂ catalyst to destroy excess O₃ present in the effluent after the VOC oxidation.

The present invention also provides a photocatalytic oxidation (PCO) system comprising a housing containing two separate inlet plenums placed at the two opposite ends of the housing, and a series of multiple hollow tubular filters (tubes) connecting the two plenums. Each of the tubular filters is a TiO₂ impregnated porous tube containing at least one multi-wavelength Type-C UV lamp having a wavelength of between and/or in combinations of 185 and 285 nm. The diameter of the filter tube is governed by the distance of the filter tube to the UV lamp. In a preferred embodiment, the lamp is placed at a distance of less than two inches from the interior surface of the filter tube allowing maximum 90 degree angle of UV exposure on the entire inside TiO₂ circumference surface to enhance its catalytic activity. The enhanced catalytic activity of TiO₂ further enhances its VOC oxidizing ability.

The UV lamp is further encapsulated in an air purged, UV transparent quartz tube to maintain an ambient temperature around the lamp of less than about 50° C. The purged air passing through the annular space between the quartz tube and the lamp generates ozone and hydroxyls by the reaction with 185 nm UV light with the oxygen present in the ambient purged air. The resulting ozone and hydroxyls aid in the oxidation of VOCs.

The present application provides a method of oxidizing VOCs in an effluent gas stream (i.e., gaseous vapor stream) to carbon dioxide and water in a photo catalytic environment by passing the VOC-laden effluent gas through a porous inorganic substrate, impregnated with raw, powdered TiO₂ or surface sol-gel coated with powdered TiO₂ (and/or a mixture of other catalyzing agents such as tungsten, copper, cobalt, etc.), present within an ultraviolet light/ozone/hydroxyl flux field.

In one embodiment of the invention, the porous inorganic substrate may comprise a tubular filter of thin walled carbon fiber, activated carbon fiber, alumina-silicate fiber or sintered metal. Inorganic porous filters of the invention provide a large surface area, flexibility, varying porosities, resistance to UV deterioration, and improved ability to withstand heat. The porosity of the filter is chosen to be large enough to allow the passage of the effluent gas containing VOCs while yet small enough to prevent the TiO₂ particulate material from passing through the filter.

The passage of heated effluent gas through the filter increases the temperature of the porous material, sometimes to temperatures well beyond the temperature limitation of organic filter media materials. A porous material capable of withstanding high temperatures therefore is necessary when additional process heat is added and/or necessary for further catalytic destruction of VOCs. The catalytic process continues within the thin wall of the porous substrate impregnated with TiO₂, and beyond the immediate surface, where UV radiation barely penetrates, when the effluent gas containing VOCs is at a sufficiently high temperature, or is heated to a sufficiently high temperature by an optional infra-red lamp located within the exhaust plenum. It should be understood that the infra-red lamp in the system is optional. Therefore in one implementation the system and associated method are free of the addition of outside heat to the system other than that minimal amount of incident heat generated by the use of a UV lamp to generate UV light for activating the TiO₂ catalyst on the one hand and converting oxygen to ozone and hydroxyls on the other hand. Avoiding the use of additional heat, e.g., use of an infra-red lamp, reduces the energy costs associated with the system and method, especially in comparison to the prior art's usage of heat in a catalytic system.

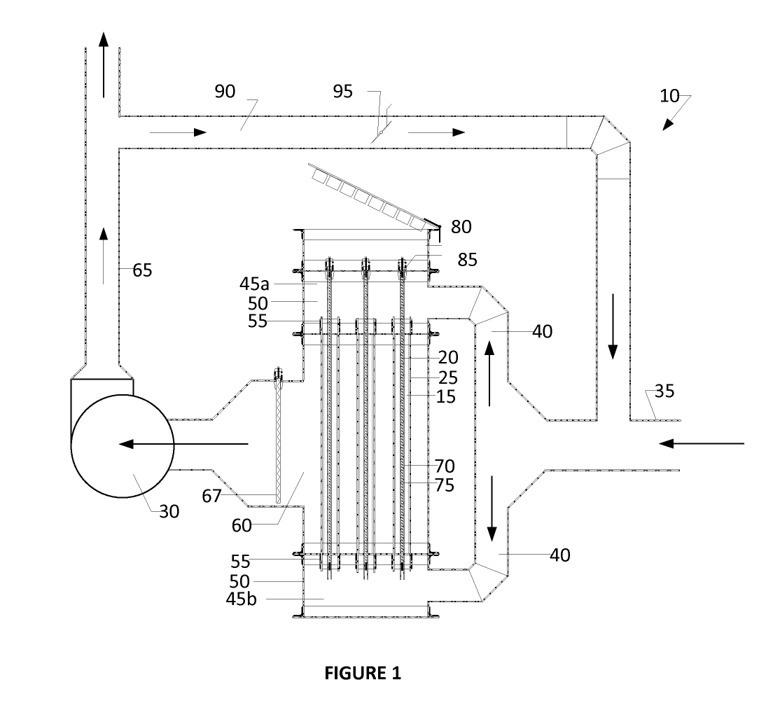

FIG. 1 illustrates a photocatalytic oxidation system 10 that takes effluent gas (gaseous vapors) containing VOCs and passes the gas through channels 15 containing UV lights 20. The channels are formed by TiO₂ impregnated inorganic porous filter tubes 25 in which the UV lights are mounted, thereby creating a UV light/ozone flux field. A blower 30 downstream of the porous filter tubes 25 creates a vacuum that pulls the effluent gas into the channels 15 and through the walls of the filter tubes 25. The combination of the UV light, ozone, hydroxyls and TiO₂ catalyst oxidizes the VOCs in the gas to carbon dioxide and water.

The photocatalytic oxidation system 10 of FIG. 1 consists of an inlet tube 35 that splits into a pair of feeder tubes 40 that each connects to a plenum or chamber 45a, 45b. Each plenum includes a wall 50 in which the filter tubes 25 and UV lights 20 are mounted. A mounting fixture 55 for each filter tube/UV light combination is arranged to hold the filter tubes 25, create a generally air-tight seal with the plenum wall 50, and form a lengthwise, longitudinal channel for receiving the UV light 20. The filter tube is mounted to the mounting fixture 55 with a seal such that a gas flowing into the mounting fixture will pass into the channel in the filter tube rather than between the mounting fixture and the filter tube.

An exhaust plenum or chamber 60 is formed on the opposite side of the plenum walls 50. The exhaust chamber 60 is in connection to an outlet line 65 containing the blower 30. The chamber 60 is in a fluid connection with the plenums 45a, 45b only by the porosity of the filter tubes 25. Therefore a gas flowing in the inlet tube 35 will pass through the outlet tube 65 only by first passing through the porous filter tubes 25. It should be understood that the exhaust from each filter tube will enter a common exhaust plenum 60. In one embodiment of the invention, the exhaust plenum is heated using an optional infra-red heat source 67. This enhances the oxidation process by exciting the TiO₂ entrapped in the filter media, thus destroying additional VOCs that may have escaped oxidization as the VOC laden air passed through the porous tubes.

The exhaust plenum provides additional advantages. For example, the exhaust plenum slows the velocity of the exit fume to provide addition dwell time in the presence of an optional infra-red heat lamp. The exhaust plenum also provides equal distribution of the VOCs through the filter tubes.

Each filter tube 25 extends through the exhaust plenum 60 and is mounted in one pair of mounting fixtures 55 positioned on opposite sides of the exhaust plenum. Effluent gas containing VOCs will pass through the feeder tubes 40 into the plenums 45a, 45b, next be pulled into the mounting fixtures 55 and finally be pulled into the channel 15. In this manner, when an individual filter tube 25 is positioned within two mounting fixtures 55 in the two plenum walls 50, the gas will be either pushed or pulled into the walls of the filter tubes because there is no other outlet from the plenums. By being pushed or pulled into the TiO₂ impregnated walls, some of the VOCs will be oxidized into CO₂ and water. This provides one method of oxidizing the VOC-laden effluent. However, as explained below, the use of a TiO₂ catalyst on its own provides only partial oxidation of the VOCs and its use in conjunction with UV light exciting the TiO₂ catalyst provides a significant increase in VOC oxidation.

It should be understood that the porosity of the porous filter tube is carefully selected. The particle size of TiO₂ powder must not be smaller than the filter tube's ability to stop the powder from passing through the pores. In one embodiment of the invention, the particle size of TiO₂ powder cannot be greater than 5 microns. Because the inner surface of the porous tube wall must remain coated with powdered TiO₂ or other form of TiO₂ to effectively catalyze the reaction, the blower 30 must not pull the TiO₂ through the pores. To accomplish this, the porosity of the filter is selected such that the VOC-laden gas will pass through the filter but leave the powdered TiO₂ coating undisturbed on the surface for continuous use. As explained below, because the inner surface of the tube is completely radiated with UV radiation hitting the TiO₂ coating at its maximum angle, the catalyst provides maximum oxidation of VOCs passing through the TiO₂ porous wall.

An additional advantage is provided by selecting the porosity of the filter tube so as to avoid the TiO₂ from being pulled through the pores. Current methods of rejuvenating a TiO₂ catalyst system involves the tedious and expensive steps of applying a catalytic coating to the filter tubes, such as the sol-gel method which involves coating porous filter bags with a TiO₂ solution and which must be replenished as it is abraded by the velocity of the inlet gas passing over it. In the present invention, raw, powdered TiO₂ can be fed into the system, for example into feeder tubes 40, and pulled into the channels 15 by the vacuum created by the blower 30. Once in the channels 15, the TiO₂ will line the surface and pores on the surface of the channel. In this manner, the TiO₂ coating can be maintained in spite of loss of material over time.

A second mechanism of cleaning the VOCs-laden air is by the use of UV light. As explained above, the UV lights 20 are positioned within the channels 15 and irradiate the VOC-laden gas passing into the channels 15 and filter tubes 25. By positioning the UV lights 20 within than two inches or less of the inner surface of the TiO₂ coated channel 15, the UV radiation will reach the TiO₂ impregnated-surface of the filter tube. Irradiating the TiO₂ surface will aid in the catalytic oxidation of the VOC-laden gas. In particular, low wavelength UV light excites the TiO₂ catalyst. When the UV light excites the TiO₂ catalyst the effectiveness of its catalytic capabilities is significantly increased compared to UV light on its own or TiO₂ on its own. Therefore, the most effective use of the system 10 involves the combined use of the TiO₂ catalyst and the UV light irradiated on the TiO₂ catalyst. Further, the lower the wavelength of the UV light, the more the TiO₂ catalyst is excited and results in greater oxidation of the VOCs. For this reason a wavelength below 285 nm is preferred.

A third mechanism of cleaning the VOC-laden gas is by the use of ozone and hydroxyls to oxidize the VOCs. The ozone and hydroxyls are produced when oxygen and water vapor (i.e., humidity) in a purge air stream passes by the UV lights and is irradiated by the UV light. Specifically, the ultra-short wavelength radiation at 185 nm or less generated by the UV light 20 generates the ozone (O₃) from oxygen (O₂) and hydroxyls from the ambient humidity in the purge air. The UV lights are used in one aspect of the invention to irradiate the VOC-laden gas and TiO₂ catalytic surface. However, if the VOC-laden gas is at an elevated temperature, the UV lamp will be overheated and operate ineffectively. It is known that the lights operate most effectively when maintained at a temperature of less than approximately 50° C. To maintain the optimal operating temperature, a purge stream of cooling air is passed over the lights themselves. The exposure of the oxygen in the purge stream fortuitously converts a portion of the oxygen to an OH radical, an O radical (hydroxyls) and ozone. Each UV light 20 is positioned within the center of a respective quartz tube 70 and forms a channel 75 between the outer walls of the UV lights and the inner surface of the quartz tube. The cooling purge air is passed within the channel 75. As seen in FIG. 1, the quartz tubes extend between the two plenums 45a, 45b and pass through the mounting fixtures 55.

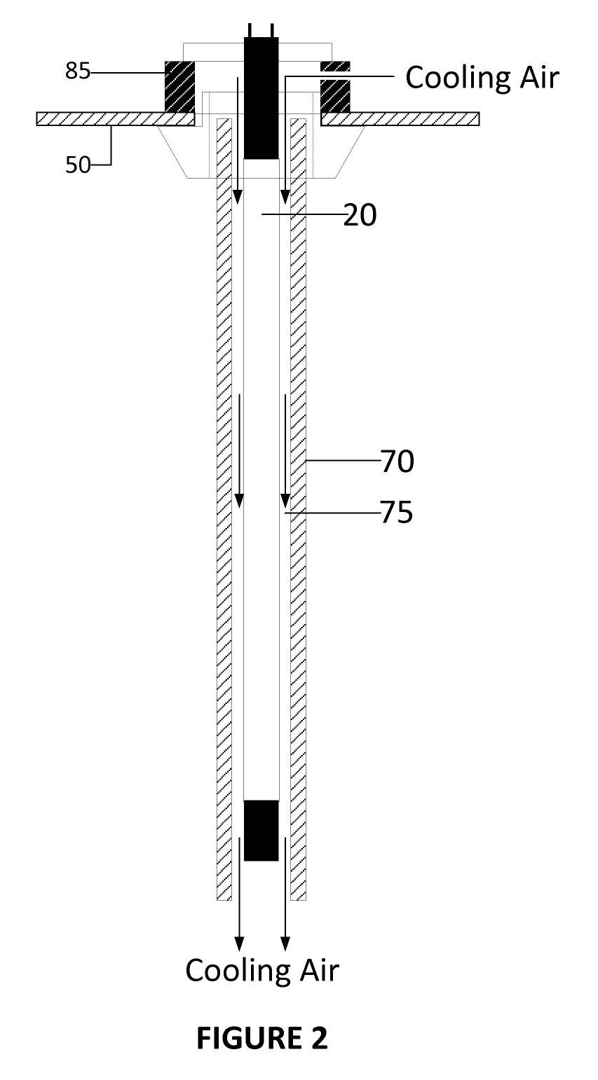

In a typical arrangement, as illustrated in FIG. 1, a ballast junction box 80 is positioned adjacent to the plenum 45a. The UV lights 20 and quartz tubes 70 are mounted to the junction box 80. As further illustrated in greater detail in FIG. 2, the cooling purge air enters the quartz tube 70 in a receiving socket fixture 85 in the junction box 80 and passes through the quartz tube in the channel or annular space between the quartz tube and the UV light positioned within the tube. One end of the quartz tube is within, adjacent to or mounted with the receiving socket fixture. The opposite end of the quartz tube is positioned within the second plenum 45b and has an opening for the purge air to pass out of the quartz tube into the second plenum. The purge air and ozone in the plenum 45b will be pulled into the mounting fixtures 55 along with the VOC-laden gas.

The primary difference between the purge air that enters the quartz tube in plenum 45a and the purge air that passes out of the quartz tube into plenum 45b is the reduction of the amount of oxygen in the air and the corresponding increase in the amount of ozone and hydroxyls in the air. Similarly, as should be evident, the primary difference between the gas in plenum 45a and in plenum 45b is the presence in plenum 45b of the purge air and oxygen mixing with the VOC-laden gas. As should be understood, the configuration illustrated in FIG. 1 with a single junction box can be modified such that, for example, the system has two opposing junction boxes with both plenums being adjacent to a junction box. In this manner, purge air with ozone can be pumped into each plenum if such uniformity is desirable or provides sizing advantages.

In one embodiment, the system 10 includes a recycle line 90 that takes a portion of the cleaned gas passing through the outlet tube 65 and recirculates that portion of gas to the inlet line 35. Although the throughput may be reduced by recirculating some of the gas, the levels of VOCs in the exhaust gas ultimately will be reduced. The amount of recirculation can be controlled, e.g., with a valve 95, to optimize variables such as efficiency, throughput, VOC removal, and cost.

In operation, the VOC-laden gas from an industrial operation is pulled by the vacuum created by the blower 30 through inlet tube 35, into the feeder tubes 40 and into the plenums 45a, 45b. In the embodiment of FIG. 45b, the VOC-laden gas mixes with the ozone produced by the purge air passing through the quartz tubes 70 adjacent to the UV lamps 20. The presence of ozone and hydroxyls with the VOC-laden gas converts some of the VOCs to water and carbon dioxide. From the plenums 45a, 45b, the VOC-laden gas is pulled by the blower 30 through the mounting fixtures 55 into the channels 15 in the filter tubes 25. The positioning of the UV lamps 20 in the quartz tubes within the channels is configured such that the UV lamps are within two inches or less from the inner surface of the channel 15 of the filter tube 25. The VOC-laden gas within the channel is irradiated by the UV light and more of the VOCs are converted to carbon dioxide and water. The presence of the TiO₂ on the surface and into the pores of the porous filter tube 25 also provides a catalytic surface for still further conversion of the VOCs into carbon dioxide and water vapor. The vacuum created by the blower 30 continues to pull the now-treated gas through the pores into and through the exhaust plenum 60 into outlet tube 65.

Various modifications to the photocatalytic oxidation system 10 are envisioned. For example, the length and number of porous filter tubes used depend on the desired surface area, velocity and the volume of effluent gas and air flowing through the PCO system. FIG. 1 illustrates a system using three filter tubes 25 and three UV lamps 20. In other implementations, a system can include a single filter tube and UV lamp, two filter tubes and UV lamps, four filter tubes and UV lamps, etc. The size and quantity of the filter tubes and UV lamps are selected to sufficiently clean the gas effluent passing through the system. Further, the arrangement of the UV light source with the filter tube can be such that ozone generation is optional, e.g., no quartz tube and/or purge air. In this manner, the system and method consist of, or consist essentially of, a filter tube having a channel coated with TiO₂ and a UV light within the filter tube to irradiate the circumferential surface of the channel through the filter tube to activate the TiO₂ catalyst. Similarly, the system and method may consist of, or consist essentially of, the filter tube having a channel coated with TiO₂ and a UV light within the filter tube to irradiate the circumferential surface of the channel through the filter tube to activate the TiO₂ catalyst, and a quartz tube surrounding the UV light and means to provide a purge air stream through the quartz tube to permit generation of ozone and hydroxyls that is fed to the channel in the filter tube for treating VOCs passing through the channel into the filter tube.

The arrangement of the UV light source with the porous filter tube is important for operation. The lamps have selected wavelengths between, and/or in combination with each other of, 185 nm and 285 nm Each lamp is placed in a parallel arrangement in the center of the respective filter tube in approximately 1.25″ proximity to the filter tube's inner catalytic surface. The inner diameter of the porous filter tube depends on the distance from the inner surface of the tube to the outer surface of the UV lamp. This distance is critical as the intensity of the UV radiation diminishes quickly with distance from the source. In one embodiment of the invention, the distance between the inner surface of the filter tube and the outer surface of the UV lamp is less than 2.5″ to 2″ to allow maximum radiation to reach the catalyst surface. In other embodiments, the distance is less than 1.75″, less than 1.5″, less than 1.25″, less than 1.0″, less than 0.75″, etc.

In a still another variation of the invention, a small amount of cobalt is added to the TiO₂ catalyst to destroy any excess of O₃ present in the discharged clean process gas after VOC oxidation. Of course, like the TiO₂ the cobalt should be of a size that it will not be pulled through the pores of the filter.

In another variation of the system, the blower 30 may be placed upstream in the inlet tube 35. In this manner, the blower pushes, rather than pulls, the VOC-laden gas through the porous filter tube.

In another variation of the system, the infra-red heater is optional and either present or not present. For example, where the combination of TiO₂, UV light, ozone, and hydroxyls are sufficient to clean the gaseous vapors of VOCs, then an infra-red heater is not necessary. When used, the infra-red heater is placed in the system such that it can heat the filter tubes to increase the activity of the TiO₂.

In another variation of the system, the system is used to treat pathogens in the ambient air of the system. It is known that UV light can be used to kill pathogens, such as viruses and bacteria. The system described herein can be configured on a scale that permits home use, institutional use and/or commercial use such as hospitals, schools, etc. to remove pathogens from the air.

The reference numbers for the figures described above are as follows:
10 Photocatalytic Oxidation System
15 Channels through filter tubes
20 UV lamps
25 Filter tubes
30 Blower or fan
35 Inlet tube
40 Feeder tubes
45a,b Plenum or chambers
50 Plenum wall
55 Mounting fixture for filter tube/UV lamp
60 Exhaust plenum or chamber
65 Outlet tube or line
67 Heat source
70 Quartz tube
75 Channel through quartz tube
80 Ballast junction box
85 Receiving socket fixture
90 Recycle line
95 Valve for controlling flow through recycle line

While several particular forms of the invention have been illustrated and described, it will be apparent that various modifications and combinations of the invention detailed in the text and drawings can be made without departing from the spirit and scope of the invention. For example, the porous inorganic substrate can be sol-gel coated with TiO₂ powder and/or a mixture of other catalyzing agents such as tungsten, copper, cobalt, etc. Similarly, high temperature porous material may be used when additional catalytic excitation is required by the addition of heat, which is well beyond the temperature limitation of organic filter media. Similarly, references to methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A photocatalytic oxidation system for catalytic oxidation of volatile organic compounds (VOCs) comprising
(i) at least one porous filter tube having a first end, a second end and a first longitudinal channel extending the length of the at least one filter tube between a first opening at the first end of the at least one porous filter tube and a second opening at the second end of the at least one porous filter tube, wherein the at least one porous filter tube has a wall extending between an inner surface surrounding the channel and an outer surface, wherein the wall comprises pores having an average pore diameter;
(ii) a catalyst comprising TiO₂ having a particle size that is greater than the average pore diameter on the surface of the inner surface of the wall;
(iii) at least one UV transparent quartz tube having a first end, a second end and a second longitudinal channel extending the length of the quartz tube between a first opening at the first end of the quartz tube and a second opening at the second end of the quartz tube, wherein the quartz tube has an inner diameter and the quartz tube is positioned within the first longitudinal channel of the respective at least one filter tube; and
(iv) at least one UV lamp capable of producing UV light, the at least one UV lamp having an outer surface defining an outer diameter of the at least one UV lamp, wherein the outer diameter of the at least one UV lamp is less than the inner diameter of the at least one quartz tube, the at least one UV lamp being positioned within the second longitudinal channel of the respective at least one quartz tube such that a space is formed between the outer surface of the lamp and an inner surface of the quartz tube,
wherein the distance between the outer surface of the lamp and the inner surface of the filter tube is less than about 2.5 inches,
whereby during operation purged air passing through the space between the outer surface of the lamp and the inner surface of the quartz tube is exposed to a UV light generated by the UV lamp to convert at least a portion of the oxygen in the air to ozone, and the UV light from the UV lamp contacts the TiO₂ surface to activate the TiO₂ catalyst.

2. The photocatalytic oxidation system of claim 1, wherein the at least one UV lamp provides an upper end UV type C radiation and an ultra-short wavelength type C radiation.

3. The photocatalytic oxidation system of claim 2, wherein the upper end UV type C radiation has a wavelength of below about 285 nm and the ultra-short wavelength type-C radiation has a wavelength of below about 185 nm.

4. The photocatalytic oxidation system of claim 1, wherein the at least one UV lamp has a single wavelength at about 185 nm.

5. The photocatalytic oxidation system of claim 1, further comprising a first plenum, a second plenum and an exhaust plenum, wherein the first opening of the at least one filter tube opens to the first plenum, the second opening of the at least one filter tube opens to the second plenum and the at least one filter tube passes through the exhaust plenum such that the outer surface of the at least one filter tube wall is within the exhaust plenum, wherein the first plenum is generally sealed off from the exhaust plenum and the second plenum is generally sealed off from the exhaust plenum such that a gas in either the first plenum or the second plenum cannot enter the exhaust plenum through a wall separating the exhaust plenum from either the first plenum or the second plenum.

6. The photocatalytic oxidation system of claim 5, further comprising an inlet tube to the first plenum and the second plenum and an exhaust tube from the exhaust plenum, wherein gas flowing in the inlet tube must pass through either or both of the first plenum and the second plenum, into the first longitudinal channel in the at least one filter tube, through the wall of the at least one filter tube, into the exhaust plenum and out through the exhaust tube.

7. The photocatalytic oxidation system of claim 6, further comprising a blower in either or both of the inlet tube and the exhaust tube.

8. The photocatalytic oxidation system of claim 5, further comprising a source of air into the first opening in the at least one quartz tube, whereby during operation the purge air passing through the space between the outer surface of the at least one lamp and the inner surface of the at least one quartz tube will pass out of the second opening in the at least one quartz tube into the second plenum.

9. The photocatalytic oxidation system of claim 1, wherein the catalyst further comprises cobalt.

10. The photocatalytic oxidation system of claim 6, further comprising an inlet header communicating with the first plenum and the second plenum.

11. The photocatalytic oxidation system of claim 1, wherein the distance between the outer surface of the lamp and the inner surface of the filter tube is less than about 2.0 inches.

12. The photocatalytic oxidation system of claim 1, wherein the distance between the outer surface of the lamp and the inner surface of the filter tube is less than about 1.5 inches.

13. A method for treating a gas containing volatile organic compounds, the method comprising providing a photocatalytic oxidation system comprising at least one porous filter tube, a catalyst, at least one UV transparent quartz tube and at least one UV lamp, wherein (i) the least one porous filter tube has a first end, a second end and a first longitudinal channel extending the length of the at least one filter tube between a first opening at the first end of the at least one porous filter tube and a second opening at the second end of the at least one porous filter tube, wherein the at least one porous filter tube has wall extending between an inner surface surrounding the channel and an outer surface, wherein the wall comprises pores having an average pore diameter; (ii) the catalyst comprises TiO₂ having a particle size that is greater than the average pore diameter on the surface of the inner surface of the wall; (iii) the at least one UV transparent quartz tube having a first end, a second end and a second longitudinal channel extending the length of the quartz tube between a first opening at the first end of the quartz tube and a second opening at the second end of the quartz tube, wherein the quartz tube has an inner diameter and is positioned within the first longitudinal channel of the respective at least one filter tube; and (iv) the at least one UV lamp capable of producing UV light has an outer surface defining an outer diameter of the at least one UV lamp, wherein the outer diameter of the at least one UV lamp is less than the inner diameter of the quartz tube, the at least one UV lamp being positioned within the second longitudinal channel of the respective at least one quartz tube such that a space is formed between the outer surface of the lamp and an inner surface of the quartz tube,
the method comprising
passing the VOC-laden gas into the first and second openings of the first longitudinal channel of the porous filter tube and through the walls of the porous filter tube; and
powering the UV lamp to provide UV light,
whereby the UV light activates the TiO₂ catalyst to oxide at least a portion of the VOCs in the VOC-laden gas as the gas passed through the catalyst.

14. The method of claim 13 for treating a gas containing volatile organic compounds, the method further comprising providing purge air to a first opening into the space between the outer surface of the UV lamp and the inner surface of the quartz tube, the purge air passing through the space from the first opening to the second opening and out of the second opening and into either the first opening or the second opening of the porous filter tube, whereby the UV light from the UV lamp converts at least a portion of the oxygen in the purge air to ozone.

15. The method of claim 14 for treating a gas containing volatile organic compounds, the method further comprising passing the purge air and ozone from the second opening of the quartz tube into either the first opening or the second opening of the first longitudinal channel of the porous filter tube.

16. The method of claim 13 for treating a gas containing volatile organic compounds, wherein the photocatalytic oxidation system further comprises a first plenum, a second plenum and an exhaust plenum, wherein the first opening of the at least one filter tube opens to the first plenum, the second opening of the at least one filter tube opens to the second plenum and the at least one filter tube passes through the exhaust plenum such that the outer surface of the at least one filter tube wall is within the exhaust plenum, wherein the first plenum is generally sealed off from the exhaust plenum and the second plenum is generally sealed off from the exhaust plenum such that a gas in either the first plenum or the second plenum cannot enter the exhaust plenum through a wall separating the exhaust plenum from either the first plenum or the second plenum,
the method further comprising passing the VOC-laden gas into the first and second openings of the first longitudinal channel of the porous filter tube further comprises passing the VOC-laden gas from the first and second plenums into the first and second openings of the first longitudinal channel.

17. The method of claim 16 for treating a gas containing volatile organic compounds, wherein the photocatalytic oxidation system further comprises an inlet tube to the first plenum and the second plenum and an exhaust tube from the exhaust plenum, and a blower in either or both of the inlet tube and the exhaust tube,
the method further comprising using the blower to move the VOC-laden gas from the inlet tube to the first and second plenum, into the first and second openings in the longitudinal channel of the porous filter tube, through the wall of the porous filter tube into the exhaust plenum, and to the exhaust tube.
wherein gas flowing in the inlet tube must pass through either or both of the first plenum and the second plenum, into the first longitudinal channel in the at least one filter tube, through the wall of the at least one filter tube, into the exhaust plenum and out through the exhaust tube.

18. The method of claim 13 for treating a gas containing volatile organic compounds, wherein the distance between the outer surface of the lamp and the inner surface of the filter tube is less than about 2.0 inches.

19. The method of claim 14 for treating a gas containing volatile organic compounds, wherein the purged air is maintained an ambient temperature of less than 50° C. to cool the UV lamp.

20. The method of claim 13 for treating a gas containing volatile organic compounds, wherein the VOCs comprise one or more of carbon monoxide, ethyl acetate, ethylene glycol, toluene, and xylene.

21. The method of claim 13 for treating a gas containing volatile organic compounds, wherein the catalyst further comprises cobalt.

22. The method of claim 13 for treating a gas containing volatile organic compounds, wherein the UV lamp has output of wavelengths between and/or in combinations of 185 and 285 nm.

23. The method of claim 13 for treating a gas containing volatile organic compounds, further comprising heating the exhaust plenum with an infra-red light.

24. A method of oxidizing volatile organic compounds (VOCs) in a gaseous vapor, the method comprising passing a VOC-laden gaseous vapor through a filter tube containing a porous inorganic substrate, impregnated and surface coated with TiO₂ powder, present within an UV light/ozone flux field wherein the UV light is operated at wavelengths between and/or in combinations of 185 and 285 nm and the UV light is generated by a lamp that is encapsulated in an air purged, UV transparent quartz tube such that ozone is created by contact of the UV light with the oxygen in the purge air and the ozone and purge air passes through the filter tube with the VOC-laden gaseous vapor, wherein the VOCs are oxidized without the addition of heat.
